(19) United States
(12) Patent Application Publication
(10) Pub. No.: US 2025/0298569 A1
(43) Pub. Date: Sep. 25, 2025

(54) TERMINAL OPERATION MANAGEMENT APPARATUS, TERMINAL OPERATION MANAGEMENT METHOD, AND STORAGE MEDIUM STORING TERMINAL OPERATION MANAGEMENT PROGRAM

(71) Applicant: HONDA MOTOR CO., LTD., Tokyo (JP)

(72) Inventor: Hajime Yokoyama, Tokyo (JP)

(21) Appl. No.: 19/016,104

(22) Filed: Jan. 10, 2025

(30) Foreign Application Priority Data
Mar. 21, 2024 (JP) 2024-044532

(51) Int. Cl. G06F 3/14; H04W 4/021

(52) U.S. Cl. CPC G06F 3/1423; H04W 4/021

(57) ABSTRACT

A terminal operation management apparatus includes: a communication terminal position recognition section that recognizes a position of a communication terminal relative to a display apparatus, the communication terminal existing around the display apparatus; and a terminal operation permission determination section that enables operation of the display apparatus through the communication terminal when the position of the communication terminal relative to the display apparatus is a predetermined position.

### INCORPORATION BY REFERENCE

The present application claims priority under 35 U.S.C. § 119 to Japanese Patent Application No. 2024-044532 filed on Mar. 21, 2024. The content of the application is incorporated herein by reference in its entirety.

### BACKGROUND OF THE INVENTION

### Field of the Invention

The present invention relates to a terminal operation management apparatus, a terminal operation management method, and a storage medium storing a terminal operation management program.

### Description of the Related Art

Conventionally, a technology has been known in which a plurality of operation devices and a plurality of displays are connected to a main body of a computer system through a cable, and any of the plurality of displays is made exclusively accessible to each operation device (for example, see Japanese Translation of PCT International Application Publication No. 1999-503849).

Moreover, a technology has been known in which a display apparatus that displays a plurality of screens on a single display at the same time identifies positions of a plurality of remote controllers relative to the display, and assigns a screen nearer to each remote controller as a screen to be operated through the remote controller (for example, see Japanese Patent Laid-Open No. 2008-34977).

According to the configuration disclosed in Japanese Translation of PCT International Application Publication No. 1999-503849, a combination of a display and an operation device to operate the display is determined by a connection state of the cable. Accordingly, operation of a display apparatus through a communication terminal that performs wireless communication is not supported.

According to the configuration disclosed in Japanese Patent Laid-Open No. 2008-34977, among the plurality of screens displayed on the display, a nearer one is selected as a screen to be operated through a remote controller. Accordingly, there is a disadvantage that a remote controller that is present at a fairly distant position from the display apparatus, or at a position diagonally in front of the display apparatus, which is out of the viewing angle of the display apparatus, may be set as a remote controller to operate the display apparatus, despite an intention of a user.

The present invention has been made in view of such background, and an object thereof is to provide a terminal operation management apparatus, a terminal operation management method, and a storage medium storing a terminal operation management program that make it possible to set a combination of a display apparatus and a communication terminal to operate the display apparatus, while restraining an event that runs counter to an intention of a user from occurring.

### SUMMARY OF THE INVENTION

A first aspect to achieve the object is a terminal operation management apparatus including: a communication terminal position recognition section that recognizes a position of a communication terminal relative to a display apparatus, the communication terminal existing around the display apparatus; and a terminal operation permission determination section that enables operation of the display apparatus through the communication terminal when the position of the communication terminal relative to the display apparatus is a predetermined position.

In the terminal operation management apparatus, the operation of the display apparatus through the communication terminal may be configured to include operation for using content displayed on the display apparatus.

In the terminal operation management apparatus, the communication terminal position recognition section may be configured to recognize the position of the communication terminal relative to the display apparatus, based on measurement information on a distance and an angle, the distance being a distance between the display apparatus and the communication terminal, the angle being an angle of a direction from the display apparatus toward the communication terminal with respect to a predetermined reference direction.

In the terminal operation management apparatus, the predetermined position may be configured to be a position within an area of use set around the display apparatus.

In the terminal operation management apparatus, the area of use may be configured to be set on a side in a display direction of the display apparatus.

In the terminal operation management apparatus, in a state where the communication terminal is in the area of use and the operation of the display apparatus through the communication terminal is enabled, when the position of the communication terminal goes out of the area of use, the terminal operation permission determination section may be configured to maintain the state where the operation of the display apparatus through the communication terminal is enabled until a predetermined time period passes from a time point when the position of the communication terminal goes out of the area of use, or until a predetermined release operation is performed by a user of the communication terminal.

In the terminal operation management apparatus, when a plurality of the communication terminals exists within the area of use, the terminal operation permission determination section may be configured to enable the operation of the display apparatus through all of the communication terminals existing within the area of use.

In the terminal operation management apparatus, when a plurality of the communication terminals exists within the area of use, the terminal operation permission determination section may be configured to enable the operation of the display apparatus through only any one communication terminal existing within the area of use.

In the terminal operation management apparatus, when a plurality of the communication terminals exists within the area of use, the terminal operation permission determination section may be configured to determine, for each of the communication terminals individually, whether or not to enable the operation of the display apparatus through the communication terminal, based on functionality that the communication terminal has.

In the terminal operation management apparatus, for each of a plurality of the display apparatuses, the communication terminal position recognition section may be configured to individually recognize the position of the communication terminal relative to the display apparatus, and for each of the plurality of the display apparatuses, the terminal operation permission determination section may be configured to individually determine whether or not the position of the communication terminal relative to the display apparatus is the predetermined position, and individually determine whether or not to enable the operation of the display apparatus through the communication terminal.

In the terminal operation management apparatus, the terminal operation permission determination section may be configured to exclude the display apparatus that is not displaying a screen from the display apparatuses for which it is determined whether or not to enable the operation through the communication terminal.

In the terminal operation management apparatus, the predetermined position may be configured to be a position within an area of use set around the display apparatus, the area of use being set with respect to each of the display apparatuses, and the terminal operation management apparatus may be configured to further include an area-of-use change section that changes the area of use, according to the number of the display apparatuses that are displaying a screen, or a position where the display apparatus that is displaying a screen is disposed.

In the terminal operation management apparatus, the predetermined position may be configured to be a position within an area of use set around the display apparatus, the area of use being set with respect to each of the display apparatuses, and with regard to a first display apparatus and a second display apparatus included in the plurality of the display apparatuses, in a state where the communication terminal is in a first area of use that is the area of use set with respect to the first display apparatus and operation of the first display apparatus through the communication terminal is enabled, when a change in position of the communication terminal causes the position of the communication terminal to be displaced into a second area of use that is the area of use set with respect to the second display apparatus, the terminal operation permission determination section may be configured to disable the operation of the first display apparatus through the communication terminal and enable operation of the second display apparatus through the communication terminal, and also switch an output destination of content displayed on the first display apparatus from the first display apparatus to the second display apparatus.

A second aspect to achieve the object is a terminal operation management method that is executed by a computer, including: a communication terminal position recognition step of recognizing a position of a communication terminal relative to a display apparatus, the communication terminal existing around the display apparatus; and a terminal operation permission determination step of enabling operation of the display apparatus through the communication terminal when the position of the communication terminal relative to the display apparatus is a predetermined position.

A third aspect to achieve the object is a storage medium storing a terminal operation management program that causes a computer to function as: a communication terminal position recognition section that recognizes a position of a communication terminal relative to a display apparatus, the communication terminal existing around the display apparatus; and a terminal operation permission determination section that enables operation of the display apparatus through the communication terminal when the position of the communication terminal relative to the display apparatus is a predetermined position.

According to the terminal operation management apparatus, the terminal operation management method, and the storage medium storing the terminal operation management program, it is possible to set a combination of a display apparatus and a communication terminal to operate the display apparatus, while restraining an event that runs counter to an intention of a user from occurring.

### BRIEF DESCRIPTION OF THE DRAWINGS

FIG. 1 is an explanatory diagram of an aspect of using a terminal operation management apparatus;

FIG. 2 is a configuration diagram of the terminal operation management apparatus;

FIG. 3 is an explanatory diagram of an area of use set with respect to a display apparatus;

FIG. 4 is an explanatory diagram of an aspect of changing a range of use of a display apparatus according to a position where the display apparatus displaying a screen is disposed;

FIG. 5 is a flowchart of processing of determining whether or not to enable operation of a display apparatus through a communication terminal;

FIG. 6 is an explanatory diagram of an embodiment in which operation of a display apparatus in a screen turned-off state through a communication terminal is disabled;

FIG. 7 is an explanatory diagram of an embodiment in which display apparatuses to be operated are switched according to a change in position of the communication terminal, and displaying of content is handed over;

FIG. 8 is an explanatory diagram of an embodiment in which when the communication terminal is temporarily displaced to outside of the area of use, a state where display operation through the communication terminal is enabled is maintained; and

FIG. 9 is an explanatory diagram of a situation in which a plurality of communication terminals exists in the area of use.

### DETAILED DESCRIPTION OF THE INVENTION

### 1. Aspect of Use of Terminal Operation Management Apparatus

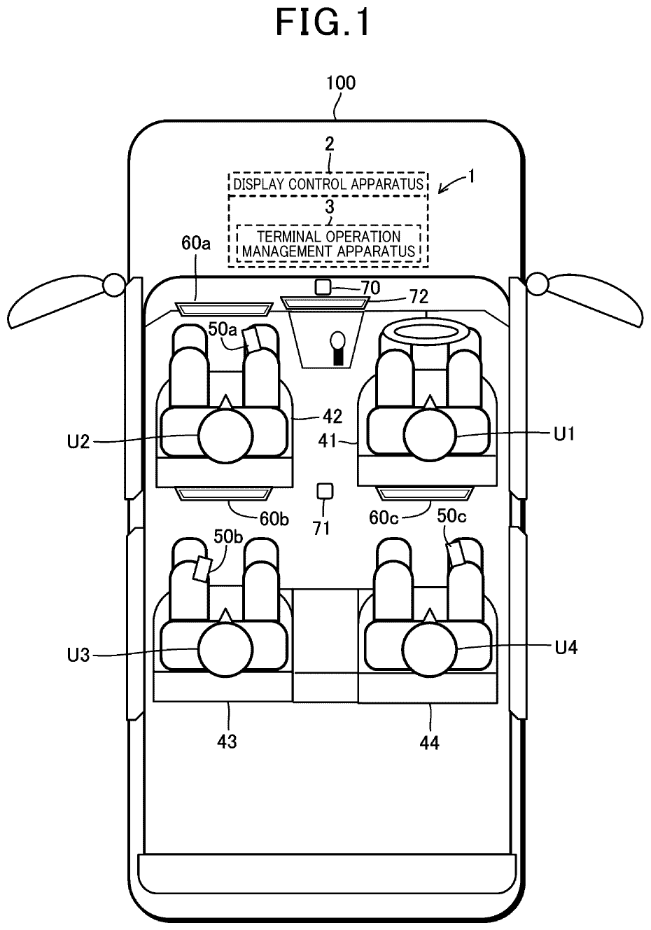

An aspect of using a terminal operation management apparatus 3 according to an embodiment is described with reference to FIG. 1. The terminal operation management apparatus 3 in the present embodiment is configured as part of functionality of a display control apparatus 2 mounted in a vehicle 100. The display control apparatus 2 is, for example, a control unit of a DA (Display Audio) 1 including a display apparatus. The DA 1 includes the display control apparatus 2 and the display apparatus for which output of an image and sound is controlled by the display control apparatus 2. FIG. 1 shows a situation in which a user U1 sits in a driver seat 41, a user U2 sits in a passenger seat 42, a user U3 sits in a left rear seat 43, and a user U4 sits in a right rear seat 44.

In the present embodiment, as display apparatuses that are controlled by the display control apparatus 2, a center display apparatus 72 disposed at the center of a dashboard, a passenger-seat display apparatus 60a disposed in front of the passenger seat 42, a left-rear-seat display apparatus 60b disposed in front of the left rear seat 43, and a right-rear-seat display apparatus 60c disposed in front of the right rear seat 44 are included in the vehicle 100. The user U2 has a communication terminal 50a, the user U3 has a communication terminal 50b, and the user U4 has a communication terminal 50c.

Hereinafter, the passenger-seat display apparatus 60a, the left-rear-seat display apparatus 60b, and the right-rear-seat display apparatus 60c are also collectively referred to as the display apparatuses 60, the communication terminals 50a to 50c are also collectively referred to as the communication terminals 50, and the users U2 to U4 are also collectively referred to as the users U. The display apparatuses 60 have a function of performing wireless communication based on a communication standard, such as Bluetooth (R) or UWB (Ultra-Wide Band), with the communication terminals 50. The communication terminals 50 include a communication terminal that has a function of performing operation through wireless communication, such as a smartphone, a mobile phone, a gaming controller, or wireless headphones.

Moreover, a front-seat camera 70 that captures an image of a view in a range including the driver seat 41 and the passenger seat 42, and a rear-seat camera 71 that captures an image of a view in a range including the left rear seat 43 and the right rear seat 44 are included in the vehicle 100. The terminal operation management apparatus 3 executes a process of determining whether or not to enable operation, through the communication terminals 50, of the display apparatuses 60.

### 2. Configuration of Terminal Operation Management Apparatus

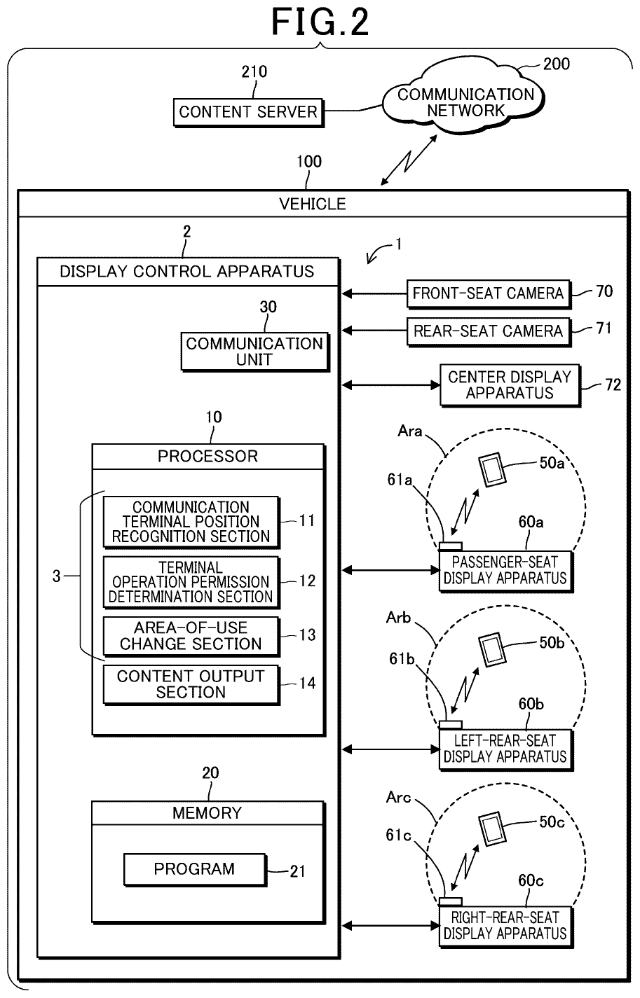

A configuration of the terminal operation management apparatus 3 is described with reference to FIG. 2. The display control apparatus 2 includes a processor 10, a memory 20, a communication unit 30, and the like. The display control apparatus 2 is connected to the front-seat camera 70, the rear-seat camera 71, the center display apparatus 72, the passenger-seat display apparatus 60a, the left-rear-seat display apparatus 60b, and the right-rear-seat display apparatus 60c.

The passenger-seat display apparatus 60a includes a communication unit 61a that performs wireless communication with a communication terminal 50. Similarly, the left-rear-seat display apparatus 60b includes a communication unit 61b, and the right-rear-seat display apparatus 60c includes a communication unit 61c. Hereinafter, the communication unit 61a, the communication unit 61b, and the communication unit 61c are also collectively referred to as the communication units 61. Note that places where the communication units 61, which perform wireless communication with the communication terminals 50, are disposed may be other than the display apparatuses 60. For example, the communication units 61 may be disposed at a plurality of places in a vehicle cabin, or a communication unit 61 may be disposed only at a place in the front of the vehicle cabin (at the position of the DA 1).

The communication unit 30 is, for example, a TCU (Telematics Control Unit) having a transmitter and a receiver and downloads data on various types of content (a game, a video, music, and the like) from a content server 210 by performing communication with the content server 210 via a communication network 200. A program 21 for control of the DA 1 is stored in the memory 20. The program 21 includes a terminal operation management program of the present disclosure.

The processor 10 functions as a communication terminal position recognition section 11, a terminal operation permission determination section 12, an area-of-use change section 13, and a content output section 14 by reading and executing the program 21. The communication terminal position recognition section 11, the terminal operation permission determination section 12, and the area-of-use change section 13 constitute the terminal operation management apparatus 3.

A process that is executed by the communication terminal position recognition section 11 corresponds to a communication terminal position recognition step in a terminal operation management method of the present disclosure, and a process that is executed by the terminal operation permission determination section 12 corresponds to a terminal operation permission determination step in the terminal operation management method of the present disclosure.

For each of the display apparatuses 60, the communication terminal position recognition section 11 recognizes a position of a communication terminal 50 existing around the display apparatus 60 relative to the display apparatus 60. The communication terminal position recognition section 11 calculates a distance between the display apparatus 60 and the communication terminal 50, based on a reception level of radio waves received by the communication unit 61. Moreover, the communication terminal position recognition section 11 calculates an angle of a direction from the display apparatus 60 toward the communication terminal 50 with respect to a reference direction of the display apparatus 60 (for example, a direction in which the front of the display apparatus 60 faces), based on combinations of the distances between a plurality of antennas installed on the communication unit 61 and the communication terminal 50. Then, the communication terminal position recognition section 11 recognizes the position of the communication terminal 50 relative to the display apparatus 60, according to the distance between the display apparatus 60 and the communication terminal 50 and the angle of the direction from the display apparatus 60 toward the communication terminal 50. Note that a method of recognizing a position of a communication terminal 50 relative to a display apparatus 60 is not limited to the above-described method, and another recognition method may be used, such as determining the distance and the angle, for example, based on a time period taken from transmission to reception and a time difference or a phase difference occurring when reception is performed by the plurality of antennas.

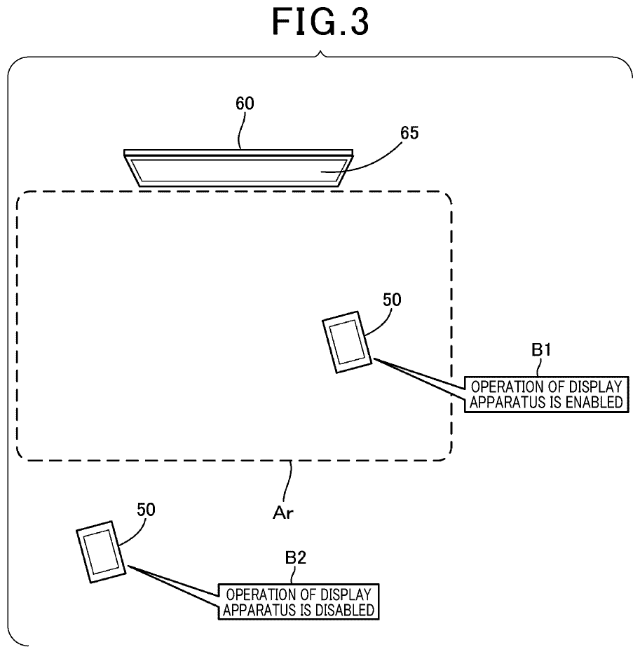

The terminal operation permission determination section 12 determines whether or not the position of the communication terminal 50 recognized by the communication terminal position recognition section 11 is within an area of use Ar set in front of a display face 65 of the display apparatus 60, as shown in FIG. 3. When the position of the communication terminal 50 is within the area of use Ar, the terminal operation permission determination section 12 enables operation of the display apparatus 60 through the communication terminal 50, as indicated by callout B1. Here, when the terminal operation permission determination section 12 determines that the communication terminal 50 is within the area of use Ar, it may be displayed on the display apparatus 60 that operation through the communication terminal 50 is permitted. Alternatively, a request to perform a specific operation (pressing a button, tapping “notify”, or the like) from the communication terminal 50 is displayed on the display apparatus 60, and upon receiving an input of the specific operation on the communication terminal 50, operation of the display apparatus 60 through the communication terminal 50 may be permitted. In contrast, when the position of the communication terminal 50 is out of the area of use Ar, the terminal operation permission determination section 12 disables operation of the display apparatus 60 through the communication terminal 50, as indicated by callout B2.

As shown in FIG. 2, an area of use Ara is set with respect to the passenger-seat display apparatus 60a, an area of use Arb is set with respect to the left-rear-seat display apparatus 60b, and an area of use Arc is set with respect to the right-rear-seat display apparatus 60c. The example in FIG. 2 shows a state where operation of the passenger-seat display apparatus 60a through the communication terminal 50a is enabled, operation of the left-rear-seat display apparatus 60b through the communication terminal 50b is enabled, and operation of the right-rear-seat display apparatus 60c through the communication terminal 50c is enabled.

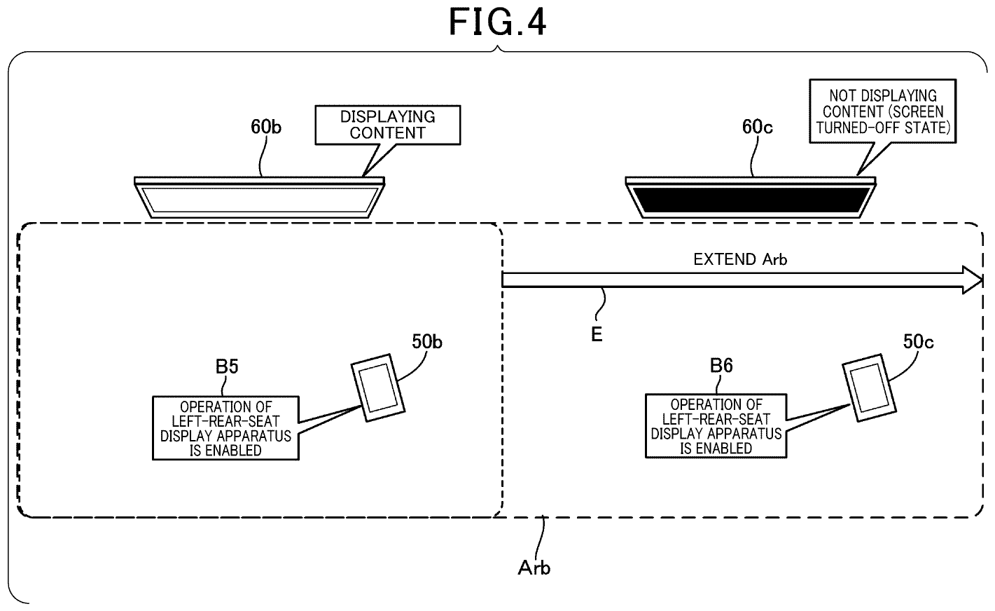

The area-of-use change section 13 changes the area of use Ar, according to the number of display apparatuses 60 that are displaying a screen, or a position where a display apparatus 60 that is displaying a screen is disposed. FIG. 4 shows a case in which the left-rear-seat display apparatus 60b is displaying content, and the right-rear-seat display apparatus 60c is not displaying content (screen turned-off state). In such a case, the area-of-use change section 13 extends the area of use Arb set with respect to the left-rear-seat display apparatus 60b to a right-rear-seat display apparatus 60c side, as indicated by arrow E. Thus, for example, when the user U3 sitting in the left rear seat 43 (see FIG. 1) shifts the sitting position to a right rear seat 44 side during a break or the like, it is possible to maintain the state where the user U3 can operate the left-rear-seat display apparatus 60b through the communication terminal 50b, and hence to enhance convenience of the user U3.

### 3. Processing of Determining Whether or not to Permit Terminal Operation

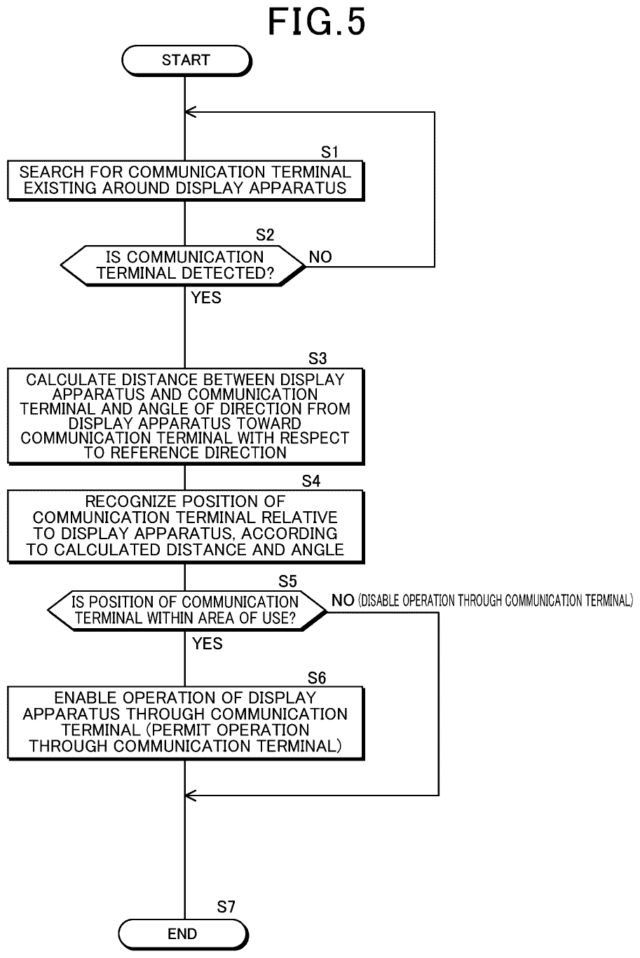

A procedure for processing of determining whether or not to permit terminal operation, which is executed by the terminal operation management apparatus 3, is described by following a flowchart shown in FIG. 5. When the DA 1 is in a powered-on state, the terminal operation management apparatus 3 executes the processing according to the flowchart shown in FIG. 5 repeatedly, for each of the display apparatuses 60, and determines whether or not to permit operation of the display apparatus 60 through a communication terminal 50.

In step S1 in FIG. 5, the communication terminal position recognition section 11 searches for a communication terminal 50 existing around a display apparatus 60, based on reception status of radio waves received by the communication unit 61 of the display apparatus 60. In subsequent step S2, the communication terminal position recognition section 11 moves the processing to step S3 when a communication terminal 50 is detected, and moves the processing to step S1 when a communication terminal 50 is not detected.

In step S3, the communication terminal position recognition section 11 calculates a distance between the display apparatus 60 and the communication terminal 50 and an angle of the direction from the display apparatus 60 toward the communication terminal 50 with respect to the reference direction, as described above. In subsequent step S4, the communication terminal position recognition section 11 recognizes a position of the communication terminal 50 relative to the display apparatus 60, according to the calculated distance and angle.

In next step S5, the terminal operation permission determination section 12 determines whether or not the position of the communication terminal 50 relative to the display apparatus 60 is within the area of use Ar, as described with reference to FIG. 3. The terminal operation permission determination section 12 moves the processing to step S6 when the position of the communication terminal 50 is within the area of use Ar, and moves the processing to step S7 when the position of the communication terminal 50 is out of the area of use Ar.

In step S6, the terminal operation permission determination section 12 enables operation of the display apparatus 60 through the communication terminal 50. Thus, as indicated by callout B1 in FIG. 3, a state is brought about in which the display apparatus 60 can be operated through the communication terminal 50.

### 4. Other Embodiments

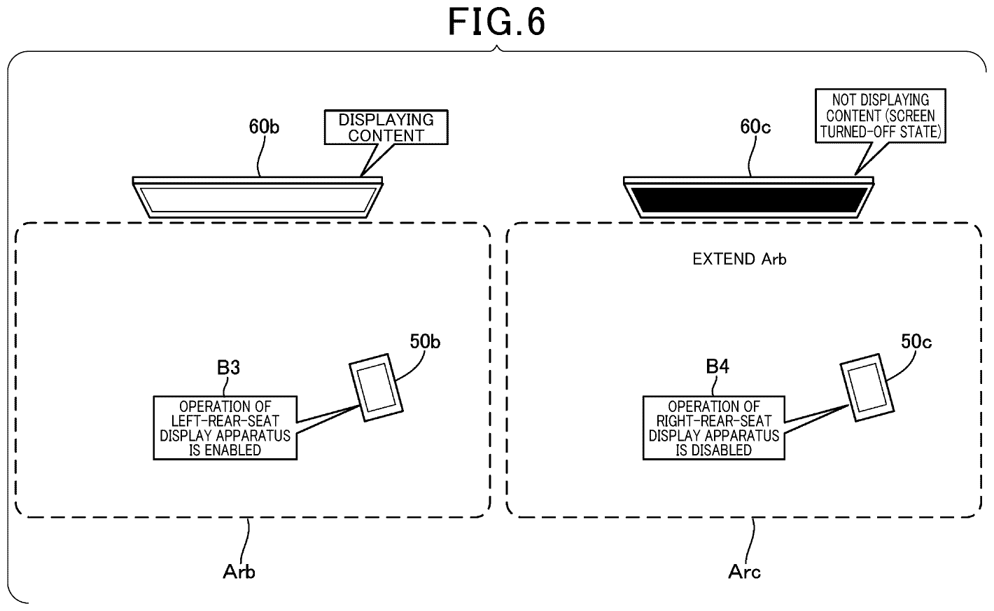

Other embodiments of the processing of determining whether or not to permit operation of a display apparatus 60 through a communication terminal 50 are described with reference to FIGS. 6 to 9.

FIG. 6 shows a case in which the left-rear-seat display apparatus 60b is displaying content, and the right-rear-seat display apparatus 60c is not displaying content (screen turned-off state). In such a case, the terminal operation permission determination section 12 excludes the right-rear-seat display apparatus 60c in the screen turned-off state from display apparatuses for which it is determined whether or not to permit operation through a communication terminal 50. Thus, with regard to the left-rear-seat display apparatus 60b that is displaying content, operation thereof through the communication terminal 50b existing in the area of use Arb set with respect to the left-rear-seat display apparatus 60b is enabled. In contrast, the right-rear-seat display apparatus 60c in the screen turned-off state falls in a state where operation thereof through the communication terminal 50c existing in the area of use Arc set with respect to the right-rear-seat display apparatus 60c is disabled. As a result, for example, when the user U4 holding the communication terminal 50c (see FIG. 1) gets in the vehicle 100, it is possible to prevent displaying of content on the right-rear-seat display apparatus 60c from being started against an intention of the user U4 as a result of operation of the right-rear-seat display apparatus 60c through the communication terminal 50c being automatically enabled.

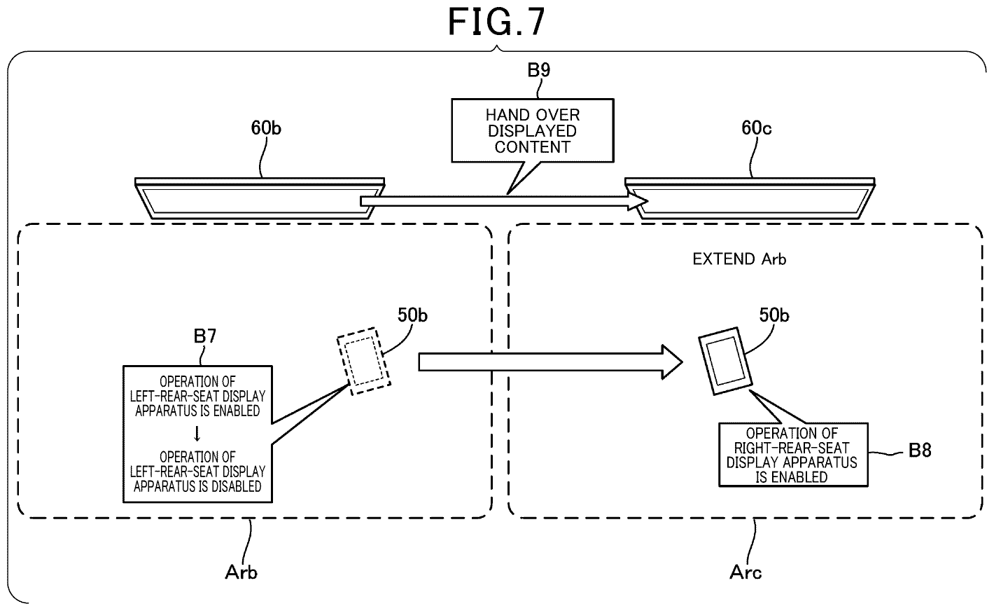

FIG. 7 shows a case in which the user U3 holding the communication terminal 50b and sitting in the left rear seat 43 (see FIG. 1) shifts to the right rear seat 44, and the communication terminal 50b is displaced from the inside of the area of use Arb set with respect to the left-rear-seat display apparatus 60b, into the area of use Arc set with respect to the right-rear-seat display apparatus 60c. In FIG. 7, the left-rear-seat display apparatus 60b corresponds to a first display apparatus of the present disclosure, and the area of use Arb corresponds to a first area of use of the present disclosure. The right-rear-seat display apparatus 60c corresponds to a second display apparatus of the present disclosure, and the area of use Arc corresponds to a second area of use of the present disclosure. In such a case, the terminal operation permission determination section 12 disables operation of the left-rear-seat display apparatus 60b through the communication terminal 50b as indicated by callout B7, and enables operation of the right-rear-seat display apparatus 60c through the communication terminal 50b as indicated by callout B8.

Moreover, as indicated by callout B9, the terminal operation permission determination section 12 switches an output destination of the content outputted by the content output section 14 to the left-rear-seat display apparatus 60b and displayed thereon, to the right-rear-seat display apparatus 60c. Thus, the user U3 who has shifted from the left rear seat 43 to the right rear seat 44 can continue to view, on the right-rear-seat display apparatus 60c, the content that has been viewed on the left-rear-seat display apparatus 60b.

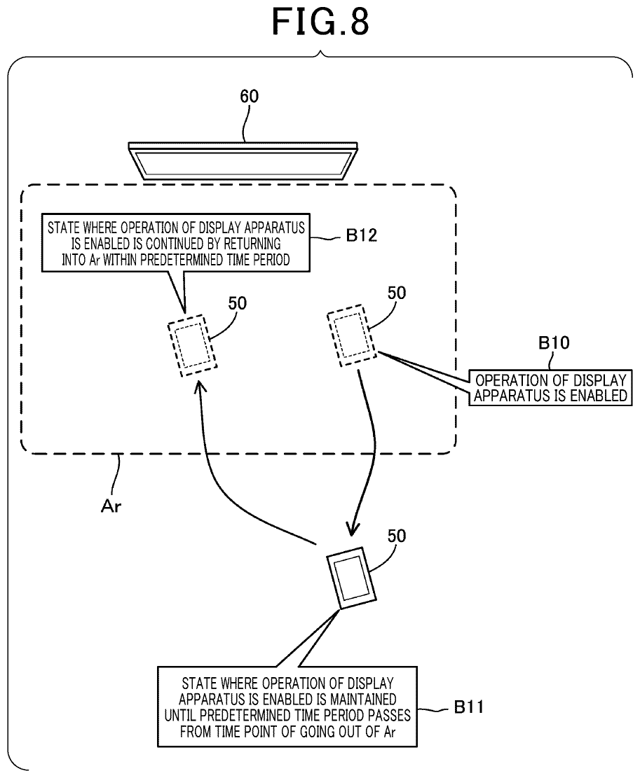

FIG. 8 shows a case in which a communication terminal 50 existing in an area of use Ar set with respect to a display apparatus 60 temporarily goes out of the area of use Ar. In such a case, the terminal operation permission determination section 12 maintains a state where operation of the display apparatus 60 through the communication terminal 50 is enabled, until a predetermined time period passes from a time point when the communication terminal 50 goes out of the area of use Ar. Thus, for example, when a user U temporarily shifts to another seat, it is possible to prevent operation of the display apparatus 60 through the communication terminal 50 from being disabled, and hence to enhance convenience of the user U.

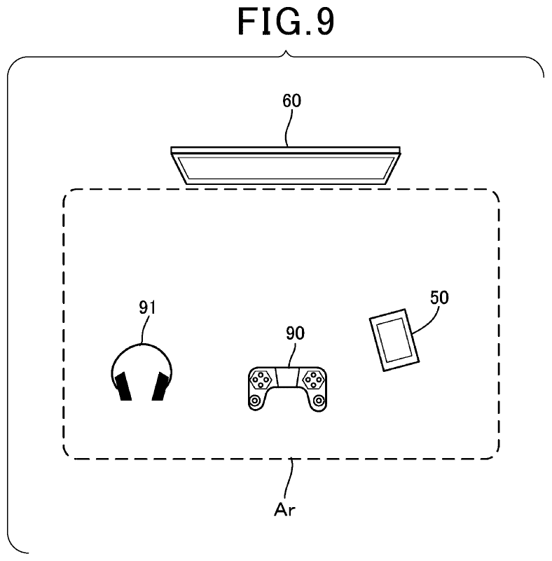

FIG. 9 shows a case in which a plurality of communication terminals exists in an area of use Ar set with respect to a display apparatus 60. In FIG. 9, the case is shown in which as the communication terminals, a gaming controller 90 and wireless headphones 91, in addition to a communication terminal 50 as described above, exist in the area of use Ar.

In such a case, the terminal operation permission determination section 12 may execute processing for following multiple-terminal handlings 1 to 3.

Multiple-terminal handling 1: The terminal operation permission determination section 12 enables operation of the display apparatus 60 through all of the plurality of communication terminals (in FIG. 9, the communication terminal 50, the gaming controller 90, the wireless headphones 91) existing in the area of use Ar.

Multiple-terminal handling 2: The terminal operation permission determination section 12 enables operation of the display apparatus 60 through only any one communication terminal of the communication terminals existing in the area of use Ar. For example, the terminal operation permission determination section 12 enables operation of the display apparatus 60 through only a communication terminal that is detected first. Alternatively, the terminal operation permission determination section 12 may enable operation of the display apparatus 60 through only a communication terminal on which a specific operation (pressing a button, tapping, or the like) is performed first.

Multiple-terminal handling 3: For each of the communication terminals, the terminal operation permission determination section 12 determines, based on functionality that the communication terminal has, whether or not to enable operation of the display apparatus 60 through the communication terminal. For example, when a user U causes the display apparatus 60 to display game content and plays a game, the terminal operation permission determination section 12 may enable operation of the display apparatus 60 through the gaming controller 90, which has dedicated functionality that supports gaming operations, and may disable operation of the display apparatus 60 through the communication terminal 50 and the wireless headphones 91. Alternatively, among communication terminals of different functions or types, operation of the display apparatus 60 through only one communication terminal per function or type may be enabled. In the example in FIG. 9, operation of the display apparatus 60 through the different types of communication terminals for one user, namely, one gaming controller 90, one pair of wireless headphones 91, and one communication terminal 50 (smartphone or the like), is enabled.

In the embodiment, the communication terminal position recognition section 11 recognizes a position of a communication terminal 50 relative to a display apparatus 60, based on communication status between the communication terminal 50 and the communication unit 61 of the display apparatus 60. As another embodiment, the communication terminal position recognition section 11 may recognize a position of a communication terminal 50 relative to a display apparatus 60, based on images captured by the front-seat camera 70 and the rear-seat camera 71. In such a case, the communication terminal position recognition section 11 recognizes a position of a communication terminal 50 existing around the passenger-seat display apparatus 60a relative to the passenger-seat display apparatus 60a by extracting an image portion of the communication terminal 50 from an image captured by the front-seat camera 70. The communication terminal position recognition section 11 recognizes a position of a communication terminal 50 existing around the left-rear-seat display apparatus 60b relative to the left-rear-seat display apparatus 60b by extracting an image portion of the communication terminal 50 from an image captured by the rear-seat camera 71. The communication terminal position recognition section 11 recognizes a position of a communication terminal 50 existing around the right-rear-seat display apparatus 60c relative to the right-rear-seat display apparatus 60c by extracting an image portion of the communication terminal 50 from an image captured by the rear-seat camera 71.

Note that FIG. 2 is a schematic diagram showing the configurations of the terminal operation management apparatus 3 and the vehicle 100 that are segmented based on main processing contents in order to facilitate the understanding of the invention of the present disclosure, and the configurations of the terminal operation management apparatus 3 and the vehicle 100 may be made based on other segments. A process by each constituent element may be executed by one hardware unit, or may be executed by a plurality of hardware units. A process by each constituent element shown in FIG. 5 may be executed based on one program, or may be executed based on a plurality of programs.

### 5. Configurations Supported by the Embodiments Described Above

The above-described embodiments are specific examples of the following configurations.

(Configuration 1) A terminal operation management apparatus including: a communication terminal position recognition section that recognizes a position of a communication terminal relative to a display apparatus, the communication terminal existing around the display apparatus; and a terminal operation permission determination section that enables operation of the display apparatus through the communication terminal when the position of the communication terminal relative to the display apparatus is a predetermined position.

According to the terminal operation management apparatus in configuration 1, when the position of the communication terminal relative to the display apparatus is the predetermined position, operation of the display apparatus through the communication terminal is enabled. Thus, it is possible to set a combination of a display apparatus and a communication terminal to operate the display apparatus, while restraining an event that runs counter to an intention of the user from occurring.

(Configuration 2) The terminal operation management apparatus according to configuration 1, wherein the operation of the display apparatus through the communication terminal includes operation for using content displayed on the display apparatus.

According to the terminal operation management apparatus in configuration 2, it is possible to select a communication terminal to perform operation for using content displayed on the display apparatus, while restraining an event that runs counter to an intention of the user from occurring.

(Configuration 3) The terminal operation management apparatus according to configuration 1 or 2, wherein the communication terminal position recognition section recognizes the position of the communication terminal relative to the display apparatus, based on measurement information on a distance and an angle, the distance being a distance between the display apparatus and the communication terminal, the angle being an angle of a direction from the display apparatus toward the communication terminal with respect to a predetermined reference direction.

According to the terminal operation management apparatus in configuration 3, by using the distance and angle parameters, it is possible to simplify the processing of measuring the position of the communication terminal relative to the display apparatus, and to reduce the required amount of information.

(Configuration 4) The terminal operation management apparatus according to any one configuration of configurations 1 to 3, wherein the predetermined position is a position within an area of use set around the display apparatus.

According to the terminal operation management apparatus in configuration 4, when the user who uses the communication terminal is in an area around the display apparatus, it is possible to enable operation of the display apparatus through the communication terminal.

(Configuration 5) The terminal operation management apparatus according to configuration 4, wherein the area of use is set on a side in a display direction of the display apparatus.

According to the terminal operation management apparatus in configuration 5, it is possible to set the area of use limited to a range in which the user who operates the communication terminal can see the display apparatus.

(Configuration 6) The terminal operation management apparatus according to configuration 4 or 5, wherein in a state where the communication terminal is in the area of use and the operation of the display apparatus through the communication terminal is enabled, when the position of the communication terminal goes out of the area of use, the terminal operation permission determination section maintains the state where the operation of the display apparatus through the communication terminal is enabled until a predetermined time period passes from a time point when the position of the communication terminal goes out of the area of use, or until a predetermined release operation is performed by a user of the communication terminal.

According to the terminal operation management apparatus in configuration 6, when the user who holds the communication terminal temporarily leaves a vicinity of the display apparatus, the state is maintained where operation of the display apparatus through the communication terminal is enabled. Thus, it is possible to enhance user convenience.

(Configuration 7) The terminal operation management apparatus according to any one configuration of configurations 4 to 6, wherein when a plurality of the communication terminals exists within the area of use, the terminal operation permission determination section enables the operation of the display apparatus through all of the communication terminals existing within the area of use.

According to the terminal operation management apparatus in configuration 7, a user can operate the display apparatus by using the plurality of communication terminals. Moreover, a plurality of users can individually operate the display apparatus by using a communication terminal held by each user.

(Configuration 8) The terminal operation management apparatus according to any one configuration of configurations 4 to 7, wherein when a plurality of the communication terminals exists within the area of use, the terminal operation permission determination section enables the operation of the display apparatus through only any one communication terminal existing within the area of use.

According to the terminal operation management apparatus in configuration 8, it is possible to enable operation of the display apparatus through any one communication terminal, while avoiding competition for operation among the plurality of communication terminals.

(Configuration 9) The terminal operation management apparatus according to any one configuration of configurations 4 to 8, wherein when a plurality of the communication terminals exists within the area of use, the terminal operation permission determination section determines, for each of the communication terminals individually, whether or not to enable the operation of the display apparatus through the communication terminal, based on functionality that the communication terminal has.

According to the terminal operation management apparatus in configuration 9, for example, with regard to a plurality of communication terminals having different functions, operation of the display apparatus through all the communication terminals is enabled, and with regard to a plurality of communication terminals having a common function, operation of the display apparatus through only any one communication terminal is enabled. It is thus possible to enhance the degree of freedom of the user in selecting a communication terminal.

(Configuration 10) The terminal operation management apparatus according to any one configuration of configurations 1 to 9, wherein: for each of a plurality of the display apparatuses, the communication terminal position recognition section individually recognizes the position of the communication terminal relative to the display apparatus; and for each of the plurality of the display apparatuses, the terminal operation permission determination section individually determines whether or not the position of the communication terminal relative to the display apparatus is the predetermined position, and individually determines whether or not to enable the operation of the display apparatus through the communication terminal.

According to the terminal operation management apparatus in configuration 10, in an environment of use where a plurality of display apparatuses is deployed, a communication terminal through which operation of each display apparatus is enabled is automatically set according to a position of the communication terminal relative to the display apparatus. Accordingly, it is possible to eliminate operation, by the user, for setting communication terminals to combine with the plurality of display apparatuses, and hence to enhance user convenience.

(Configuration 11) The terminal operation management apparatus according to configuration 10, wherein the terminal operation permission determination section excludes the display apparatus that is not displaying a screen from the display apparatuses for which it is determined whether or not to enable the operation through the communication terminal.

According to the terminal operation management apparatus in configuration 11, with regard to a display apparatus that is not displaying a screen, from which it is assumed that the user has no intention to use the display apparatus, it is possible to avoid inconvenience arising, such as displaying of a screen being automatically started as a result of operation through a communication terminal being enabled, or wasteful consumption of electricity as a result of a process for receiving an operation through a communication terminal being started.

(Configuration 12) The terminal operation management apparatus according to configuration 10 or 11, wherein: the predetermined position is a position within an area of use set around the display apparatus, the area of use being set with respect to each of the display apparatuses; and the terminal operation management apparatus further includes an area-of-use change section that changes the area of use, according to the number of the display apparatuses that are displaying a screen, or a position where the display apparatus that is displaying a screen is disposed.

According to the terminal operation management apparatus in configuration 12, the area of use is changed according to the number or disposition of display apparatuses that are displaying a screen. Thus, with regard to a display apparatus that can be seen by a user, it is possible to prevent operation thereof through the communication terminal from being disabled.

(Configuration 13) The terminal operation management apparatus according to any one configuration of configurations 10 to 12, wherein: the predetermined position is a position within an area of use set around the display apparatus, the area of use being set with respect to each of the display apparatuses; and with regard to a first display apparatus and a second display apparatus included in the plurality of the display apparatuses, in a state where the communication terminal is in a first area of use that is the area of use set with respect to the first display apparatus and operation of the first display apparatus through the communication terminal is enabled, when a change in position of the communication terminal causes the position of the communication terminal to be displaced into a second area of use that is the area of use set with respect to the second display apparatus, the terminal operation permission determination section disables the operation of the first display apparatus through the communication terminal and enables operation of the second display apparatus through the communication terminal, and also switches an output destination of content displayed on the first display apparatus from the first display apparatus to the second display apparatus.

According to the terminal operation management apparatus in configuration 13, when a display apparatus that can be seen by the user is changed as a result of the user moving while holding the communication terminal, it is possible to switch the output destination of content that has been viewed by the user before moving, to a display apparatus that can be seen after moving. Thus, the user can continue to view the content also after moving.

(Configuration 14) A terminal operation management method executed by a computer, including: a communication terminal position recognition step of recognizing a position of a communication terminal relative to a display apparatus, the communication terminal existing around the display apparatus; and a terminal operation permission determination step of enabling operation of the display apparatus through the communication terminal when the position of the communication terminal relative to the display apparatus is a predetermined position.

By the computer executing the terminal operation management method in configuration 14, it is possible to bring about operations and effects similar to those of the terminal operation management apparatus in configuration 1.

(Configuration 15) A non-transitory computer-readable storage medium storing a terminal operation management program that causes a computer to function as: a communication terminal position recognition section that recognizes a position of a communication terminal relative to a display apparatus, the communication terminal existing around the display apparatus; and a terminal operation permission determination section that enables operation of the display apparatus through the communication terminal when the position of the communication terminal relative to the display apparatus is a predetermined position.

By the computer executing the terminal operation management program in configuration 15, it is possible to implement the configuration of the terminal operation management apparatus in configuration 1.

### REFERENCE SIGNS LIST

1 DA, 2 display control apparatus, 3 terminal operation management apparatus, 10 processor, 11 communication terminal position recognition section, 12 terminal operation permission determination section, 13 area-of-use change section, 14 content output section, 20 memory, 21 program, 30 communication unit, 50 (50a, 50b, 50c) communication terminal, 60 (60a, 60b, 60c) display apparatus, 70 front-seat camera, 71 rear-seat camera, 72 center display apparatus, 90 gaming controller, 91 wireless headphones, Ar (Ara, Arb, Arc) area of use, U (U1, U2, U3) user.

1. A terminal operation management apparatus comprising:
a communication terminal position recognition section that recognizes a position of a communication terminal relative to a display apparatus, the communication terminal existing around the display apparatus; and
a terminal operation permission determination section that enables operation of the display apparatus through the communication terminal when the position of the communication terminal relative to the display apparatus is a predetermined position.

2. The terminal operation management apparatus according to claim 1, wherein the operation of the display apparatus through the communication terminal includes operation for using content displayed on the display apparatus.

3. The terminal operation management apparatus according to claim 1, wherein the communication terminal position recognition section recognizes the position of the communication terminal relative to the display apparatus, based on measurement information on a distance and an angle, the distance being a distance between the display apparatus and the communication terminal, the angle being an angle of a direction from the display apparatus toward the communication terminal with respect to a predetermined reference direction.

4. The terminal operation management apparatus according to claim 1, wherein the predetermined position is a position within an area of use set around the display apparatus.

5. The terminal operation management apparatus according to claim 4, wherein the area of use is set on a side in a display direction of the display apparatus.

6. The terminal operation management apparatus according to claim 4, wherein in a state where the communication terminal is in the area of use and the operation of the display apparatus through the communication terminal is enabled, when the position of the communication terminal goes out of the area of use, the terminal operation permission determination section maintains the state where the operation of the display apparatus through the communication terminal is enabled until a predetermined time period passes from a time point when the position of the communication terminal goes out of the area of use, or until a predetermined release operation is performed by a user of the communication terminal.

7. The terminal operation management apparatus according to claim 4, wherein when a plurality of the communication terminals exists within the area of use, the terminal operation permission determination section enables the operation of the display apparatus through all of the communication terminals existing within the area of use.

8. The terminal operation management apparatus according to claim 4, wherein when a plurality of the communication terminals exists within the area of use, the terminal operation permission determination section enables the operation of the display apparatus through only any one communication terminal existing within the area of use.

9. The terminal operation management apparatus according to claim 4, wherein when a plurality of the communication terminals exists within the area of use, the terminal operation permission determination section determines, for each of the communication terminals individually, whether or not to enable the operation of the display apparatus through the communication terminal, based on functionality that the communication terminal has.

10. The terminal operation management apparatus according to claim 1, wherein
for each of a plurality of the display apparatuses, the communication terminal position recognition section individually recognizes the position of the communication terminal relative to the display apparatus, and
for each of the plurality of the display apparatuses, the terminal operation permission determination section individually determines whether or not the position of the communication terminal relative to the display apparatus is the predetermined position, and individually determines whether or not to enable the operation of the display apparatus through the communication terminal.

11. The terminal operation management apparatus according to claim 10, wherein the terminal operation permission determination section excludes the display apparatus that is not displaying a screen from the display apparatuses for which it is determined whether or not to enable the operation through the communication terminal.

12. The terminal operation management apparatus according to claim 10, wherein
the predetermined position is a position within an area of use set around the display apparatus, the area of use being set with respect to each of the display apparatuses, and
the terminal operation management apparatus further comprises an area-of-use change section that changes the area of use, according to the number of the display apparatuses that are displaying a screen, or a position where the display apparatus that is displaying a screen is disposed.

13. The terminal operation management apparatus according to claim 10, wherein
the predetermined position is a position within an area of use set around the display apparatus, the area of use being set with respect to each of the display apparatuses, and
with regard to a first display apparatus and a second display apparatus included in the plurality of the display apparatuses, in a state where the communication terminal is in a first area of use that is the area of use set with respect to the first display apparatus and operation of the first display apparatus through the communication terminal is enabled, when a change in position of the communication terminal causes the position of the communication terminal to be displaced into a second area of use that is the area of use set with respect to the second display apparatus, the terminal operation permission determination section disables the operation of the first display apparatus through the communication terminal and enables operation of the second display apparatus through the communication terminal, and also switches an output destination of content displayed on the first display apparatus from the first display apparatus to the second display apparatus.

14. A terminal operation management method executed by a computer, comprising:
a communication terminal position recognition step of recognizing a position of a communication terminal relative to a display apparatus, the communication terminal existing around the display apparatus; and
a terminal operation permission determination step of enabling operation of the display apparatus through the communication terminal when the position of the communication terminal relative to the display apparatus is a predetermined position.

15. A non-transitory computer-readable storage medium storing a terminal operation management program that causes a computer to function as:
a communication terminal position recognition section that recognizes a position of a communication terminal relative to a display apparatus, the communication terminal existing around the display apparatus; and
a terminal operation permission determination section that enables operation of the display apparatus through the communication terminal when the position of the communication terminal relative to the display apparatus is a predetermined position.
